(19) United States
(12) Patent Application Publication
(10) Pub. No.: US 2024/0210929 A1
(43) Pub. Date: Jun. 27, 2024

(54) METHOD AND DEVICE FOR QUALITY ASSURANCE OF A CONTAINER PROCESSING PLANT

(71) Applicant: Krones AG, Neutraubling (DE)

(72) Inventors: Benedikt BOETTCHER, Bruckmühl (DE); Konrad SENN, Alteglofsheim (DE); Andreas MEYER, Parkstetten (DE); Markus STUBENHOFER, Regensburg (DE); Robert AUST, Illkofen (DE)

(21) Appl. No.: 18/393,447

(22) Filed: Dec. 21, 2023

(30) Foreign Application Priority Data
Dec. 22, 2022 (DE) 10 2022 134 581.5

(51) Int. Cl. G05B 19/418

(52) U.S. Cl. CPC G05B 19/41875; G05B 2219/32368

(57) ABSTRACT

The disclosure relates to a method for quality assurance of a container processing plant, wherein the container processing plant comprises at least two container processing components, wherein a malfunction in at least one of the at least two container processing components is detected by means of a quality assurance device on the basis of a periodicity with which a deviation of a parameter from a target value in a first container processing component is determined.

### CROSS REFERENCE TO RELATED APPLICATION

The present application claims priority to German Patent Application No. 10 2022 134 581.5 filed on Dec. 22, 2022. The entire contents of the above-listed application are hereby incorporated by reference for all purposes.

### TECHNICAL FIELD

The disclosure relates to a method for quality assurance of a container processing plant according to independent claim 1 and to a corresponding apparatus according to independent claim 8.

### BACKGROUND

In the prior art, it is known to monitor the operation of container processing plants in order to detect and eliminate possible malfunctions in the container processing components of the container processing plant. It can thus be ensured that container processing can be carried out with constant quality.

### SUMMARY

For quality assurance, the machine parameters of the individual components of the container processing plant are typically monitored. If a deviation of a machine parameter from a target value is determined, the existence of a malfunction can be deduced on the basis of the deviation, and the deviation can be eliminated by readjusting a machine parameter.

Furthermore, it is known for quality assurance to metrologically record a physical property of a container after the processing and to compare it to a prespecified target value. If a deviation of the physical parameter from the target value is determined, it is possible to respond by adjusting a machine parameter.

From EP 3 681 692 B1, it is also known to record the time profile of a control parameter and to derive from the time profile of the control parameter any change in a component characteristic of a component assigned to the control parameter. In order to define maintenance intervals or maintenance dates appropriately or in order to schedule maintenance work in a manner oriented by the rate of wear of individual assemblies of the various forming stations, it is also provided to extrapolate the derived change in the component characteristic in order to estimate the future development of the component characteristic, wherein, in particular on the basis of the extrapolation, maintenance or replacement of the relevant component is scheduled.

### Technical Object to be Achieved

With regard to the prior art, the technical object of the present invention to be achieved is to specify a quality assurance method for a container processing plant, by means of which comprehensive and at the same time resource-efficient monitoring of a container processing plant can be achieved and/or any malfunction of the container processing plant can be reliably traced.

### Achievement

This object is achieved according to the disclosure by the method for quality assurance of a container processing plant according to independent claim 1 and by the corresponding apparatus according to independent claim 8. Preferred embodiments of the disclosure are included in the dependent claims.

In the method according to the disclosure for quality assurance of a container processing plant, wherein the container processing plant comprises at least two container processing components, a malfunction in at least one of the at least two container processing components is ascertained by means of a quality assurance device on the basis of a periodicity with which a deviation of a parameter from a target value is determined in a first container processing component.

With the method according to the disclosure, a possible malfunction in the first container processing component itself or in another container processing component can be identified by means of the quality assurance device on the basis of the periodicity with which a deviation of a parameter is determined in the first container processing component. In particular, it is also possible to deduce a possible malfunction in an upstream container processing component without the malfunction in the upstream container processing component itself having to be metrologically recorded. Consequently, the method according to the disclosure can achieve comprehensive and at the same time resource-efficient monitoring of the container processing components of the container processing plant and reliably detect a malfunction on the basis of the determined periodicity of the deviation. In particular, the method according to the disclosure can also detect malfunctions in container processing components that are not or cannot be monitored metrologically.

A container processing component is to be understood as a component of the container processing plant that is suitable for carrying out a processing step on a container. The container processing component can, for example, be a heating device for controlling the temperature of parisons, a blow-molding machine for shaping the parisons into containers, a filler for filling the containers with a product, a closing device for closing the filled containers, a sterilizing device for sterilizing the containers, a direct-printing device for printing on the containers, or a labeling device for labeling the containers. However, it can also be any other container processing component that is not explicitly listed here and is suitable for carrying out a processing step on a container. Each of the container processing components can comprise a multitude of container processing units so that a multiplicity of containers can be processed by each of the container processing components.

The parameter is to be understood in particular as a machine parameter of a container processing component or a physical parameter of a container. The machine parameter can, for example, be a heating power or a variable of a heating device characteristic of the heating power or a pre-blowing pressure or blowing pressure or a stretching rate of a blow-molding machine. However, it can also be any other machine parameter that is not explicitly listed here and can influence a property of the container processed by the container processing component. The physical parameter of the container in turn is understood as a parameter that describes a physical property of a container processed by a container processing component. The physical parameter can, for example, be a transmittance or absorbance of an irradiated electromagnetic radiation which is transmitted or absorbed by the wall and/or the bottom of the container. A density of the container material, the proportion of oriented or unoriented polymer chains in a container produced from a plastic, the color of the container or the like can also be used as physical parameters. The physical parameter can also be an offset injection point or the size of an injection lens. Here, the injection lens is to be understood as the center of the injection point. The examples of physical parameters listed here are to be understood as being by way of example so that the physical parameter may also be any other physical parameters that is not explicitly mentioned here and is suitable for deducing the quality of the container.

The target value is a prespecified value of the parameter. If the parameter is a machine parameter, the target value of the machine parameter can be selected, for example, on the basis of a property of a parison or container processed by the container processing plant. If the machine parameter is, for example, a heating power, the target value of the heating power can be selected on the basis of a material composition of a parison. If the parameter is a physical parameter of a container, the target value of the physical parameter can be selected in such a way as to obtain a container that satisfies a specific product requirement or has a specific property. If, for example, the container is intended to have a specific compressive strength, the target value of the physical parameter for the compressive strength can be a characteristic variable (for example, the density of the container material) by means of which the desired compressive strength of the container is achieved.

Periodicity is understood to mean that the deviation of the parameter occurs with a specific regularity. For example, it can be a temporal periodicity in which a deviation occurs repeatedly after a specific time interval has elapsed, such as after 1 s, after 5 s or 10 s. However, periodicity can also be understood to mean that, for example, in each x-th container processed by the container processing component, a deviation from a target value or, when each y-th processing process is carried out, a deviation of a parameter from a target value is determined, wherein x represents the number of containers and y represents the number of processing processes carried out, and x and y are whole numbers.

In one embodiment, on the basis of a number of control interventions already performed on at least one of the at least two container processing components in order to eliminate the malfunction, the quality assurance device can either change a machine parameter of the at least one of the at least two container processing components or output a signal that a faulty component of the one of the at least two container processing components needs to be replaced in order to eliminate the malfunction in the one of the at least two container processing components. A control intervention is here understood to mean the change in a machine parameter of the at least one of the at least two container processing components. For example, it can be provided that, if the number of the control interventions already performed is less than or equal to a limit value, the machine parameter will be changed and, if the number of the control interventions performed is greater than a limit value, a signal for a component replacement will be output. A targeted elimination of the malfunction can thus be achieved. In particular, it is possible not only to save costs for an unnecessary component exchange but also to avoid downtimes of the container processing plant caused by an unnecessary component exchange.

In one embodiment, the malfunction in the at least one of the at least two container processing components can be ascertained on the basis of the periodicity with which a deviation of a parameter from a target value in the first container processing component is determined and on the basis of a characteristic variable characteristic of the at least one of the at least two container processing components. Due to the additional consideration of the characteristic variable of at least one of the at least two container processing components, the malfunction can be identified with greater accuracy.

In one embodiment, the characteristic variable can be or comprise a number of container receptacles of the at least one of the at least two container processing components. If the characteristic variable is the number of container receptacles and if there is a malfunction in a container receptacle or a container processing unit assigned to the container receptacle, which is the faulty container receptacle or container processing unit can be deduced on the basis of the periodicity with which the deviation of the parameter in the first container processing component is determined.

In one embodiment, the parameter can be a machine parameter of the first container processing component or a physical parameter of a container. Not only the deviation of the machine parameter but also the deviation of the physical parameter of the container from a target value represents a direct indicator of the existence of a production-related fault in the container and is thus a particularly suitable parameter for checking whether there is a malfunction in a container processing component.

In one embodiment, the quality assurance device can check whether a replacement part for the faulty component is contained in a magazine assigned to the container processing plant. In the event of an irreparable malfunction of a component, it can thus be immediately checked whether a needed replacement part is available or must first be procured, and possible downtimes of the container processing plant can thus be kept as short as possible.

In one embodiment, if the replacement part is contained in the magazine, the faulty component can be replaced with the replacement part by means of a robot assigned to the container processing plant, or an operator can be signaled that the replacement part is present in the magazine assigned to the container processing plant, and the faulty component of the at least one of the at least two container processing components needs to be replaced and/or, if the faulty component is not contained in the magazine, the replacement part can be automatically reordered by the quality assurance device, or the reorder of the faulty component by the quality assurance device has to be approved by an operator. By means of this automated procedure, the required steps can be initiated immediately by the quality assurance device in the event of a faulty component, and repair-related downtimes can be kept as short as possible.

The container processing plant according to the disclosure comprises at least two container processing components for processing containers and a quality assurance device, wherein the quality assurance device is designed to detect a malfunction in at least one of the at least two container processing components on the basis of a periodicity with which a deviation of a parameter is determined in a first container processing component.

With the container processing plant according to the disclosure, a comprehensive monitoring of the container processing plant can thus be achieved with low metrological effort and the quality assurance of the container processing plant can advantageously be improved. In particular, malfunctions in container processing components that are not or cannot be monitored metrologically can also be detected.

In one embodiment, for eliminating the malfunction in the at least one of the at least two container processing components, the quality assurance device can be designed, on the basis of a number of control interventions already performed on the at least one of the at least two container processing components in order to eliminate the malfunction, either to change a machine parameter of the at least one of the at least two container processing components or to output a signal that a faulty component in the at least one of the at least two container processing components needs to be replaced in order to eliminate the malfunction in the at least one of the at least two container processing components. It is thus possible to respond in a targeted manner to the existing malfunction and, in particular, to save the costs of an unnecessary component exchange or to avoid downtimes of the container processing plant caused by an unnecessary component exchange.

In one embodiment, the quality assurance device can be designed to detect the malfunction in the at least one of the at least two container processing components on the basis of the periodicity with which a deviation of a parameter in a first container processing component is determined and on the basis of a characteristic variable characteristic of the at least one of the at least two container processing components. Due to the additional consideration of the characteristic variable of at least one of the at least two container processing components, the malfunction can be identified with greater accuracy.

In one embodiment, the characteristic variable can be or comprise a number of container receptacles of the at least one of the at least two container processing components. If the characteristic variable is the number of container receptacles and if there is a malfunction in a container receptacle or a container processing unit assigned to the container receptacle, which is the faulty container receptacle or container processing unit can be ascertained on the basis of the periodicity with which the deviation of the parameter in the first container processing component is determined.

In one embodiment, the parameter can be a machine parameter of the first container processing component or a physical parameter of a container. Not only the deviation of the machine parameter but also the deviation of a physical parameter of the container is a direct indicator of the existence of a production-related fault in the container, and they are thus particularly suitable parameters for checking whether there is a malfunction in a container processing component.

In one embodiment, the container processing plant can comprise a magazine for replacement parts for the at least two container processing components, and the quality assurance device can be designed to check whether the faulty component is contained in the magazine. By providing a magazine with replacement parts, it is possible to enable an immediate replacement of a defective component and to avoid longer downtimes of the container processing plant.

In one embodiment, the container processing plant can comprise a robot which is designed to replace the faulty component of the at least one of the at least two container processing components with a replacement part from the magazine. The replacement process can be carried out fully automatically by automatic replacement of the defective component by the robot. Repair-related downtimes of the container processing plant can thus be reduced and resources can also be saved.

In one embodiment, the quality assurance device can be connected to a server and can be designed to reorder the faulty component if the component is not contained in the magazine, wherein the reorder of the component is either carried out automatically by the quality assurance device or has to be approved by an operator. By the automated reorder of the replacement part by the quality assurance device, the process can be designed to be as time-efficient as possible. Moreover, resources can be saved and possible mistakes in the reorder, such as the reorder of an incorrect component, can be prevented.

### BRIEF DESCRIPTION OF THE FIGURES

FIG. 1: container processing plant comprising a multiplicity of container processing components and a quality assurance device according to one embodiment.

FIG. 2: a detail of a container processing plant comprising a multiplicity of container processing components and a quality assurance device according to a further embodiment.

### DETAILED DESCRIPTION OF THE FIGURES

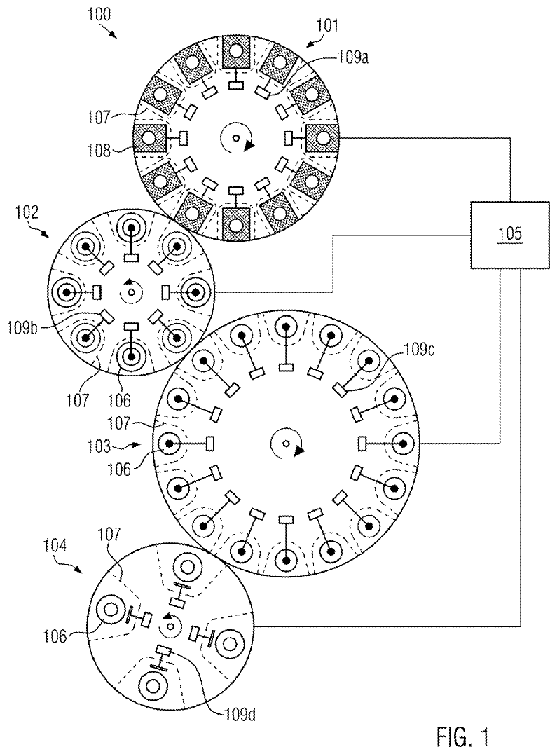

FIG. 1 shows a container processing plant 100 comprising four container processing components 101, 102, 103, 104 and a quality assurance device 105 according to one embodiment. The number of four container processing components shown in this embodiment is to be understood as exemplary and not restrictive. In an alternative embodiment, any other number of container processing components that is greater than 1 can also be provided. The quality assurance device 105 (for example, a computer or a control unit of the container processing plant) is designed to detect a malfunction in at least one of the container processing components 101, 102, 103, 104 on the basis of a periodicity with which a deviation of a parameter from a target value in a first container processing component 101, 102, 103, 104 is determined.

A container processing component 101, 102, 103, 104 is to be understood as a component of the container processing plant that is designed to carry out a processing step on a parison or a container 106. The container processing component 101, 102, 103, 104 can, for example, be a heating device for controlling the temperature of parisons, a blow-molding machine for shaping parisons into containers, a device for the surface treatment of containers, a sterilizing device for containers, a filler for filling containers with a product, a closing device for closing containers, a direct-printing device for printing on containers, or a labeling device for labeling containers. The design types of the container processing component just mentioned are to be understood as exemplary. The container processing component can also be any other container processing component that is not explicitly mentioned here and is suitable for carrying out a processing step on a container. In principle, the container processing component is understood to be a machine that can carry out at least one processing step on a container and, for this purpose, comprises at least one, preferably a multiplicity of processing stations of the same type. The processing stations of the same type are to be understood here as processing stations that are all designed to carry out the same functions.

According to the embodiments of the disclosure, the container processing components can preferably be designed as rotary machines (carousels) that each comprise the described processing stations.

The container processing plant is designed to process containers of any type. However, the containers are preferably bottles that are made of plastic or of material comprising fibers and are used in the beverage industry. However, they may also be any other type of container, such as a syringe, a tube or a can made of plastic or of material comprising fibers, as used in the food, pharmaceutical or healthcare industries.

The parameter can be a machine parameter of a container processing component 101, 102, 103, 104 or a physical parameter of a container 106. The machine parameter is in particular to be understood as a machine parameter that influences a property of a parison or container 106 processed by the container processing component 101, 102, 103, 104. If the container processing component 101, 102, 103, 104 is designed as a blow-molding machine, for example, the machine parameter can be a pre-blowing pressure or a blowing pressure or a stretching rate. The physical parameter can, for example, be a transmittance or absorbance of an irradiated electromagnetic radiation which is transmitted or absorbed by a wall and/or the bottom of the container. A density of the container material, the proportion of oriented or unoriented polymer chains in a container produced from a plastic, the color of the container or the like can also be used as physical parameters. Alternatively, the physical parameter may also be an offset injection point or the size of an injection lens. However, it can also be any other physical parameter that is not explicitly mentioned here and is suitable for deducing the quality of the container.

The target value is a prespecified value of the parameter. If the parameter is a machine parameter, the target value of the machine parameter can be selected, for example, on the basis of a property of a parison or container processed by the container processing plant. If the machine parameter is, for example, a heating power, the target value of the heating power can be selected on the basis of a material composition of a parison. If the parameter is a physical parameter of a container, the physical parameter can be selected in such a way that the container satisfies a specific product requirement, such as a specific compressive strength or a specific property.

Periodicity is understood to mean that the deviation of the parameter occurs with a specific regularity. Periodicity can be understood to mean a temporal periodicity, for example. A deviation of the parameter from a target value can thus always occur after a specific time interval has elapsed, such as after 1 s, after 5 s or 10 s. However, periodicity can also be understood to mean that, in each x-th container 106 processed by the container processing component 101, 102, 103, 104, a deviation from a target value is detected or that, in each y-th processing step carried out by a container processing component, a deviation of a parameter from a target value is detected.

In the embodiment shown in FIG. 1, the four container processing components 101, 102, 103, 104 are designed as four rotary machines 101, 102, 103, 104, wherein a multiplicity of container processing stations, each with one container receptacle 107, is arranged along the circumference of each of the four rotary machines 101, 102, 103, 104. A container receptacle is to be understood here as a receptacle that is designed to receive a container or a mold for producing a container. A container processing unit 109a, 109b, 109c, 109d (as part of the container processing station) for carrying out a processing step on a container 106 can in turn be assigned to each of the container receptacles. By equipping each of the four container processing components 101, 102, 103, 104 with a multiplicity of container receptacles 107 and container processing units 109a, 109b, 109c, 109d, a multiplicity of containers 106 can be processed by each of the container processing components 101, 102, 103, 104. In the embodiment described here, the first container processing component 101 comprises twelve container receptacles 107, the second container processing component 102 comprises eight container receptacles 107, the third container processing component 103 comprises sixteen container receptacles 107, and the fourth container processing component 104 comprises four container receptacles 107. The number of container receptacles 107 and container processing units 109a, 109b, 109c, 109d provided on or at each of the four container processing components is to be understood as exemplary. In general, each of the container processing components 101, 102, 103, 104 can have any number of container receptacles 107 and container processing units 109a, 109b, 109c, 109d.

In the exemplary embodiment in FIG. 1, the first rotary machine 101 is designed as a blow-molding machine. In each of the container receptacles 107 of the first rotary machine 101 a blow mold 108 is arranged in which parisons can be extruded by means of a blow-molding unit 109a to form a container 106. The containers produced by means of the first rotary machine 101 can then be transferred to the second rotary machine 102, wherein the second rotary machine 102 can be a filling device. A filling unit 109b is assigned to each container receptacle 107 of the second rotary machine 102 in order to fill the containers 106 with a product. The filled containers 106 are then transferred to the third rotary machine 103, which can be designed as a closing device. A closing unit 109c, by means of which the filled containers 106 can be closed, is assigned to each of the container receptacles 107 of the third rotary machine 103. The closed containers 106 are subsequently transferred to a fourth rotary machine 104, which can be a direct-printing device. A direct-printing unit 109d is assigned to each of the container receptacles of the fourth rotary machine 104 in order to provide the surface of the container 106 with a printed image.

In the embodiment discussed here, the fourth rotary machine 104 is also designed to determine a physical parameter or a property of the container in order to check the container 106 with regard to its quality. For example, the fourth rotary machine 104 can comprise a camera which can check the surface of the container 106 with regard to possible irregularities. The specific design type of the four container processing components 101, 102, 103, 104 discussed here is to be understood as exemplary. Each of the four container processing components 101, 102, 103, 104 can also be as any other type of container processing plant.

Optionally, a control unit, which is designed to control the function of a container processing component 101, 102, 103, 104, can be assigned to each of the container processing components (rotary machines) 101, 102, 103, 104. This control can be achieved, for example, by modifying a machine parameter of a container processing component. In one embodiment, the function of each of the container processing units 109a, 109b 109c, 109d of the container processing components 101, 102, 103, 104 can, for example, be controlled by means of the control device. In one embodiment, the control unit can also be designed to control the rotational speed of each of the rotary machines.

The design, discussed in connection with FIG. 1, of the container processing components as rotary machines 101, 102, 103, 104 is to be understood as exemplary. Alternatively, the container processing components may also be designed as linearly operating container processing components. It can also be provided that some of the container processing components are designed as linearly operating machines and some of the container processing components are designed as rotary machines.

The quality assurance device 105 is designed to monitor the function of the container processing plant 100, to detect a malfunction in one of the container processing components 101, 102, 103, 104 and to accurately locate the cause of the malfunction. The quality assurance device 105 is in particular designed to detect a malfunction in at least one of the container processing components 101, 102, 103, 104 on the basis of a periodicity with which a deviation of a parameter from a target value in a first container processing component (rotary machine) 101, 102, 103, 104 is determined. In one embodiment, the quality assurance device 105 can be designed as a computer. The quality assurance device 105 can be connected to the container processing components 101, 102, 103, 104 via a physical data line and can access and evaluate a multiplicity of different parameters of the container processing components 101, 102, 103, 104. Alternatively, it may also be provided that the quality assurance device 105 is connected to the individual container processing components 101, 102, 103, 104 via a wireless data connection. As already described above, the parameter can be a machine parameter of one of the container processing components or a physical parameter of a container metrologically captured by one of the container processing components 101, 102, 103, 104.

The quality assurance device 105 can comprise a storage device in which target values for the multiplicity of machine parameters of the container processing components 101, 102, 103, 104 or for the physical parameters of a container 106 are stored. In particular, a multiplicity of data sets can be stored in the storage device, which data sets are assigned to a specific type of container so that the correct data set of reference data can be accessed by means of the quality assurance device 105 even when different containers are being processed. In addition, characteristic variables for each of the container processing components 101, 102, 103, 104 can be stored in the storage device. A characteristic variable can, for example, be a number of container receptacles 107 which are arranged on each of the container processing components 101, 102, 103, 104.

By comparing the parameters provided by the container processing components with the corresponding target values, the quality assurance device 105 can determine if there is a deviation of a parameter from a target value. If a deviation of a parameter of a container processing component from a target value is determined, the quality assurance device 105 can check whether the deviation occurs repeatedly and whether the repeated occurrence of the deviation has a periodicity. For example, the quality assurance device 105 can determine whether the repeatedly occurring deviation has a temporal periodicity or whether a deviation occurs in a container processing component after a specific number of containers has been processed. On the basis of the periodicity with which a deviation of a parameter from a target value in a container processing component is determined, the quality assurance device 105 can then ascertain whether there is a malfunction in one of the container processing components. In order to detect a fault, the quality assurance device 105 can use not only the periodicity but also further characteristic variables, such as a number of container receptacles 107 of the container processing components 101, 102, 103, 104 or the rotational speeds of the container processing components, in order to be able to detect the malfunction with even greater precession.

In one embodiment, it can be provided that each of the container processing components comprises any number m of container processing stations, wherein m represents a whole number and can assume a different value for each of the container processing components. A container processing station can comprise a container receptacle and a container processing unit. If, for example, the quality assurance device now determines a deviation of a parameter from a target value in a first container processing component, the quality assurance device can be designed to check for a predetermined period Z whether the deviation of the parameter from a target value is occurring repeatedly. If a repeated occurrence of the deviation is determined, the quality assurance device can ascertain the occurrence of the deviation of the parameter from a target value as a function of the time A(t). A frequency f_{A} at which the deviation occurs can then be obtained by a Fourier transform of the function A(t) thus obtained. In one embodiment, the quality assurance device can also ascertain a plurality of frequencies f_{A1}, f_{A2}, . . . by means of the Fourier transform. This is the case if the function A(t) contains at least two deviations occurring with different temporal regularities. This can be the case, for example, if there is a malfunction in at least two different container processing components, so that a characteristic frequency can be ascertained for each of the at least two malfunctions.

On the basis of the frequency, the quality assurance device can detect a malfunction in one of the container processing components. For this purpose, the frequency f_{A} obtained via the Fourier transform can be compared to a rotational frequency f_{R}=1/Tₓ characteristic of each of the container processing components, wherein Tₓ specifies the time that a container processing component x designed as a rotary machine needs for a full rotation about its own axis. As an alternative to a time, the number of container processing stations passing through until the malfunction is repeated can also be used. The term “time” is to be understood to include both alternatives here. If the frequency f_{A} detected by the quality assurance device matches one of the frequencies f_{R} characteristic of the container processing components, the quality assurance device will be able to identify a malfunction in the container processing component associated with the frequency f_{R}. If more than one frequency is detected, the existence of a problem in more than one container processing component can also be ascertained.

In one embodiment, in order to detect the malfunction in a container processing component, the quality assurance device can additionally use a characteristic variable characteristic of each of the container processing components, such as the number of container processing stations m of a container processing component. The container processing plant can also be designed to ascertain, on the basis of the frequency f_{A} and of the parameter or frequency f_{R} characteristic of the container processing components, and/or of the number of container stations m, not the faulty container processing component but, for example, a region of the container processing component or a specific container processing station of a container processing component that has the malfunction.

If a malfunction at a container processing component cannot be determined on the basis of the detected frequency f_{A} (in particular if the frequency f_{A} does not match any characteristic frequency f_{R} of the container processing components or the Fourier transforms provide a continuous spectrum of frequencies and thus no dominant contributions of a characteristic frequency f_{A}), it can then be provided that the quality assurance device outputs a visual or acoustic error signal.

In a further embodiment, the quality assurance device 105 can, for example, determine a deviation of a parameter from a target value in every third full revolution of the fourth container processing component 104. The deviation can, for example, be an irregularity on the surface of a container which was detected with the camera optionally arranged on the fourth container processing component. Based on the fact that the fourth container processing component 104 comprises four container receptacles 107 and that the deviation of the parameter occurs in every third full revolution of the fourth container processing component 104, the quality assurance device 105 can determine that every twelfth container 106 that is being processed by the fourth container processing component 104 has a defect. On the basis of this information, the quality assurance device 105 can determine that the malfunction must be in the first container processing component 101 since only the latter has 12 container receptacles. If the quality assurance device 105 uses further parameters of the container processing components, such as the rotational angular speed at which the container processing components are rotated, the precise container receptacle and the blow mold 108 of the first container processing component 101 assigned to the container receptacle, which has a malfunction, can be identified.

In an alternative embodiment, it can be envisaged, for example, that due to the third container processing component 103 a machine parameter characteristic of the closing process deviates from a target value in every half revolution of the third container processing component 103. Since the third container processing component 103 comprises sixteen container receptacles, the quality assurance device determines that, in every eighth container closed by the third container processing component, a problem occurs during the closing of the container. On the basis of this information, the quality assurance device 105 can determine that there must be a malfunction in the second container processing component since only the latter has eight container receptacles 107 and assigned container processing units 109b. On the basis of the rotational angular speed of the container processing components, the quality assurance device 105 can again deduce which container processing unit 109b has a malfunction. In the exemplary embodiment described here, mechanical damage in the head region of the container caused by one of the filling units 109b can, for example, be responsible for the deviation of the parameter of the third container processing component 103 that is characteristic of the closing process.

In order to eliminate the existing malfunction in a container processing component 101, 102, 103, 104, a machine parameter can be readjusted, for example. For example, the faulty filling unit 109b in the embodiment just discussed can be re-centered in order to prevent contact with the head region of the container 106. Alternatively, it may also be provided for the faulty component to be replaced by a corresponding replacement part.

In one embodiment, it can be provided that, on the basis of the number of control interventions that have already been performed in order to eliminate a specific malfunction, it is decided automatically (for example, by the quality assurance device and/or a control unit of the relevant container processing component and/or a central control unit of the container processing plant) whether the problem can be eliminated by readjusting a machine parameter or whether a replacement of a component is necessary. It can thus be provided, for example, that, if the number of control interventions already performed is less than or equal to a specific limit value, a machine parameter will be readjusted. If the number of control interventions already performed is greater than a specific limit value, a signal, for example, a visual or acoustic signal that a specific component must be replaced, will be output (for example, to an operator). The limit value can be selected on the basis of the existing malfunction so that, for example, if there is a first malfunction, it is provided to perform only a small number of control interventions, such as one or two control interventions, and that, if there is a second malfunction, it is provided to perform a greater number of control interventions, such as ten or fifteen control interventions, before a component exchange is initiated. If there is a third malfunction, it can also be provided, for example, that a readjustment does not take place at all and that the faulty component is immediately replaced with a replacement part.

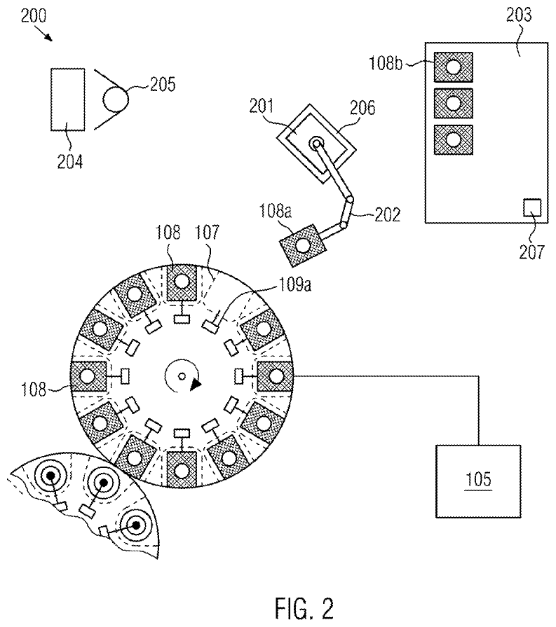

FIG. 2 shows a detail 200 of the container processing plant 100 already discussed in connection with FIG. 1, according to a further embodiment. In the embodiment shown here, the container processing plant 200 additionally comprises a magazine 203 and a robot 201. The robot 201 is designed to replace a faulty component 108a in one of the container processing components with a replacement part 108b contained in the magazine 203.

As discussed extensively in connection with FIG. 1, it can be provided that the quality assurance device 105 decides, on the basis of a number of control interventions already performed for eliminating a malfunction, whether the malfunction can be eliminated by readjusting a machine parameter or whether a replacement of the faulty component is necessary.

In order to keep repair-related downtimes of the container processing plant 200 as short as possible in the event of a component exchange, the container processing plant 200 can comprise a magazine 203 in which replacement parts 108b for the various container processing components can be stored. The magazine can also comprise a computer 207 with a storage device, wherein the storage device comprises a database in which all replacement parts 108b contained in the magazine 203 are listed.

In one embodiment, it can be provided that a unique identifier is assigned to each of the replacement parts 108b so that a replacement part 108b from the magazine 203 can be unambiguously assigned to each component of the various container processing components 101, 102, 10, 104. Alternatively, it may also be provided that a database with an overview of all replacement parts contained in the magazine 203 is centrally stored on an external server.

If the quality assurance device 105 determines that a replacement of the faulty component 108a is necessary in order to eliminate the fault, the quality assurance device 105 can simply query the database to check whether or not the faulty component is contained in the magazine 203. If the database is stored on an external server, the quality assurance device 105 can be connected to this server. If the quality assurance device 105 determines that the desired replacement part is contained in the magazine, the quality assurance device 105 can inform an operator 205 via an interface 204 about the faulty component 108a and the replacement part 108b located in the magazine 203. In addition, further information about the faulty component 108a can be provided to the operator 205.

In one embodiment, it is provided that the exchange is carried out fully automatically by the robot 201. Alternatively, it may also be provided that an operator 205 supervises the component exchange by the robot 201. For this purpose, the quality assurance device 105 can provide the robot 201 with precise information about the existing defect in the container processing component and about the precise storage location of the replacement part 108b in the magazine 203. On the basis of the information provided by the quality assurance device 105, the robot 201 can replace the faulty component of the container processing component fully automatically. The robot in turn can provide the quality assurance device 105 with information as to whether it was possible to carry out the component exchange properly or whether problems occurred during the component exchange. If the exchange was successful, the quality assurance device 105 can initiate steps so that the operation of the container processing plant is automatically resumed. If the robot reports a problem during the component exchange, the quality assurance device 105 can notify an operator 205 in order to eliminate the problem.

The robot 201 can comprise an arm 202 with a plurality of joints in order to be able to carry out even complicated component exchanges. The robot can, for example, be arranged on a trolley 206 provided with wheels and can be provided with a navigation system in order to be able to navigate through the container processing plant to the container processing components. In addition, the robot can comprise a safety system, which can detect persons present in the container processing plant and can prevent possible collisions with persons. Alternatively, rails may also be laid in the container processing plant so that the robot can move through the container processing plant and to the respective container processing components only on a path predetermined by the rails. For this purpose, the robot can be arranged on a trolley, wherein the trolley forms a linear drive with the rails. It is also possible to provide precisely one robot for each container processing component, which robot replaces replacement parts only for this container processing component. Likewise, precisely one magazine with replacement parts can be assigned separately to each container processing component.

If, on the other hand, after querying the database, the quality assurance device 105 ascertains that the faulty component is not in stock in the magazine, the component can be reordered fully automatically by the quality assurance device 105. In order to be able to make the reordering process fully automatic, the quality assurance device 105 can be connected to the internet or to a server. In an alternative embodiment, it can be provided that the ordering process is carried out semi-automatically and must first be approved by an operator 205.

1. Method for quality assurance of a container processing plant, wherein the container processing plant comprises at least two container processing components, wherein, on the basis of a periodicity with which a deviation of a parameter from a target value in a first container processing component is determined, a malfunction in at least one of the at least two container processing components is detected by means of a quality assurance device.

2. Method according to claim 1, wherein, on the basis of a number of control interventions already performed on at least one of the at least two container processing components in order to eliminate the malfunction, the quality assurance device either changes a machine parameter of the at least one of the at least two container processing components or outputs a signal that a faulty component in the one of the at least two container processing components needs to be replaced in order to eliminate the malfunction in the one of the at least two container processing components.

3. Method according to claim 1, wherein the malfunction in the at least one of the at least two container processing components is determined on the basis of the periodicity with which a deviation of a parameter from a target value in the first container processing component is determined and on the basis of a characteristic variable characteristic of the at least one of the at least two container processing components.

4. Method according to claim 3, wherein the characteristic variable is or comprises a number of container receptacles of the at least one of the at least two container processing components.

5. Method according to claim 1, wherein the parameter is a machine parameter of the first container processing component or a physical parameter of a container.

6. Method according to claim 2, wherein the quality assurance device checks whether a replacement part for the faulty component is contained in a magazine assigned to the container processing plant.

7. Method according to claim 6, wherein, if the replacement part is contained in the magazine, the faulty component is replaced with the replacement part by means of a robot assigned to the container processing plant, or an operator is signaled that the replacement part is present in the magazine assigned to the container processing plant and that the faulty component of the at least one of the at least two container processing components needs to be replaced, and/or wherein, if the faulty component is not contained in the magazine, the replacement part is automatically reordered by the quality assurance device, or wherein the reorder of the faulty component by the quality assurance device has to be approved by an operator.

8. Container processing plant comprising at least two container processing components for processing containers and a quality assurance device, wherein the quality assurance device is designed to detect a malfunction in at least one of the at least two container processing components on the basis of a periodicity with which a deviation of a parameter in a first container processing component is determined.

9. Container processing plant according to claim 8, wherein, for eliminating the malfunction in the at least one of the at least two container processing components, the quality assurance device is designed, on the basis of a number of control interventions already performed on the at least one of the at least two container processing components in order to eliminate the malfunction, either to change a machine parameter of the at least one of the at least two container processing components or to output a signal that a faulty component in the at least one of the at least two container processing components needs to be replaced in order to eliminate the malfunction in the at least one of the at least two container processing components.

10. Container processing plant according to claim 8, wherein the quality assurance device is designed to detect the malfunction in the at least one of the at least two container processing components on the basis of the periodicity with which a deviation of a parameter in a first container processing component is determined and on the basis of a characteristic variable characteristic of the at least one of the at least two container processing components.

11. Container processing plant according to claim 10, wherein the characteristic variable is or comprises a number of container receptacles of the at least one of the at least two container processing components.

12. Container processing plant according to claim 8, wherein the parameter is a machine parameter of the first container processing component or a physical parameter of a container.

13. Container processing plant according to claim 9, wherein the container processing plant comprises a magazine for replacement parts for the at least two container processing components, and wherein the quality assurance device is designed to check whether the faulty component is contained in the magazine.

14. Container processing plant according to claim 13, wherein the container processing plant comprises a robot which is designed to replace the faulty component of the at least one of the at least two container processing components with a replacement part from the magazine.

15. Container processing plant according to claim 13, wherein the quality assurance device is connected to a server and is designed to reorder the faulty component if the component is not contained in the magazine, wherein the reorder of the component is either carried out automatically by the quality assurance device or has to be approved by an operator.
